(19) United States
(12) Patent Application Publication
(10) Pub. No.: US 2015/0124615 A1
(43) Pub. Date: May 7, 2015

(54) CONGESTION AVOIDANCE AND FAIRNESS IN DATA NETWORKS WITH MULTIPLE TRAFFIC SOURCES

(71) Applicant: Oliver Solutions Ltd., Herzliya (IL)

(72) Inventors: Oren Spector, Haifa (IL); Menachem Kaplan, Tel Aviv (IL)

(21) Appl. No.: 14/507,851

(22) Filed: Oct. 7, 2014

Related U.S. Application Data
(60) Provisional application No. 61/899,230, filed on Nov. 3, 2013.

(51) Int. Cl. H04L 12/801; H04L 12/26

(52) U.S. Cl. CPC H04L 47/12; H04L 43/062; H04L 43/0882
USPC 370/235

(57) ABSTRACT

A traffic controller for a data network that includes a plurality of network nodes, a plurality of network links connecting the network nodes, and one or more edge routers, each edge router being configured to control network traffic based on permitted link capacities, and wherein one or more sources of downstream traffic data enter the network downstream of the one or more edge routers, the traffic controller including a receiver operable to periodically receive downstream transmission byte counts from at least some of the network nodes, a processor coupled with the receiver, operable to periodically update the permitted link capacities based on the network node downstream byte counts received by the receiver, and a transmitter coupled with the processor operable to periodically transmit the thus-updated permitted link capacities to the one or more edge routers for their use in controlling the network traffic.

### CROSS REFERENCES TO RELATED APPLICATIONS

This application claims priority benefit of U.S. Provisional Application No. 61/899,230, entitled CONGESTION AVOIDANCE IN DATA NETWORKS WITH MULTIPLE TRAFFIC SOURCES, filed on Nov. 3, 2013 by inventors Oren Spector and Menachem Kaplan.

### FIELD OF THE INVENTION

The present invention relates to data networks and software defined networking (SDN).

### BACKGROUND OF THE INVENTION

Data networks are comprised of network nodes, and fixed-capacity links that connect the nodes. Capacity of a link is generally measured in units of bandwidth such as bits/sec. A provider network is a data network through which customers access the Internet and other services, including inter alia voice, video, on-line gaming, file sharing, data backup and cloud storage.

Reference is made to FIG. 1, which is a prior art diagram of a provider data network 100. Provider network 100 has a single network node 10, referred to as an edge router, which serves as the customers' point of access to the provided services. Data traffic flowing from the edge router to the customer is referred to as downstream traffic, and traffic flowing in the opposite direction is called upstream traffic.

As shown in FIG. 1, media server 20A is connected to edge router 10 via Internet 30, and media server 20B is connected to edge router 10 directly. Edge router 10 is connected to aggregation devices 40A and 40B. Aggregation device 40A is connected to access terminals 50A and 50B. Examples of access terminals include:
OLT—inter alia optical line terminals, which are service provider endpoints of passive optical networks;
CMTS—cable modem termination system terminals for high-speed data services such as cable Internet and voice over IP; and
DSLAM—digital subscriber line access multiplexer terminals.
   Access terminal 50A is connected to customer premises equipment (CPE) 60A and 60B.

Network operators strive to use as much as possible of a network's capacity, yet to avoid congestion in the network. Network congestion degrades quality of service for customers who use the network, and leads to low effective utilization of the network due to re-transmissions. Network operators sign service level agreements (SLA's) with customers, and strive to enforce the SLA's in their network and ensure fairness among their customers.

Downstream traffic is directed from media servers 20A and 20B, and from Internet 30, to CPEs 60A and 60B, through network 100, by a semi-static tree structure. Specifically, as long as a network link does not fail, downstream traffic to a specific CPE always traverses the same path of network nodes. Edge router 10 identifies the destination CPE of each downstream frame that enters edge router 10, and stores each frame in a downstream queue that is associated with that destination CPE. In order to avoid congestion, ensure fairness among customers, and optimize network utilization, edge router 10 employs hierarchical traffic management, using a hierarchical scheduling and policing tree that has the same structure as that of the provider network. I.e., the root of the tree is the edge router, the vertices of the tree are the network nodes, the leaves of the tree are the downstream queues of the edge router, and the edges of the tree are network links through which downstream traffic flows between network nodes. The edge router shapes traffic flowing through a link according to the link's capacity; e.g., according to a percentage of the maximal link capacity, or according to a service level agreement in case the link is connected directly to a customer. The edge router shapes traffic by determining a data traffic rate Redge_{n,m} for the downstream link from node n to node m, for some or all of the linked network nodes n and m, and by ensuring the these traffic rates do not exceed the link capacities.

Upstream traffic is controlled by algorithms such as dynamic bandwidth allocation. However, such control is generally limited to links directly connected to CPEs. Other control algorithms, such as Resource Reservation Protocol, allocate bandwidth along a path between the CPE and the edge router. However, such control generally results in limited network utilization.

A large portion of downstream traffic in provider networks is media—video, in particular. Conventionally, media servers 10A and 10B are located on the upstream side of edge router 10, so that all media traffic passes through the edge router 10. As a result, edge router 10 becomes overloaded. Moreover, as customers expect higher video quality, the bandwidth consumed by video in a provider network becomes larger. In turn, this necessitates enlarging the capacities of edge routers.

In addition to overloading edge routers, directing media traffic through edge routers has other drawbacks.
1. Edge routers perform deep packet inspection and sophisticated hierarchical scheduling and policing, resulting in higher cost-per-bit than other devices, such as aggregation devices. Furthermore, media traffic requires only minimal processing, does not need to be shaped, and cannot be extensively delayed or lost. As such, passing media traffic through an edge router is wasteful of an expensive resource, and unnecessary.
2. Conventionally, media services are located on the upstream side of edge routers, despite the fact that placing media servers, or caches of media servers, closer to customers who consume the media would improve their user experience; nevertheless, the rationale is to enable the edge router to be aware of all downstream traffic flowing to customers, so that the edge router can avoid congestion in the provider network.

Flow control mechanisms, referred to variously as back-pressure and congestion indication, are standardized, and have been implemented over the years in various packet/cell communication technologies. Flow control mechanisms perform reasonably well in avoiding congestion for small-scale networks having few flows. However, flow control has several drawbacks.
1. Flow control provides per flow indications, whereas the congested entity is a network component, most often a link.
2. Flow control is qualitative, reporting flow congestion. As such, tuning traffic management to avoid congestion is a trial-and-error process with prolonged convergence and inefficient network resource utilization.
3. Flow control is not scalable. No device can process flow control for tens of thousands of flows.

In fact, the above deficiencies were the reason that hierarchical traffic management, currently used by edge routers, was introduced—the rationale being that since flow control cannot resolve congestion as it occurs, then congestion must be avoided altogether. To accomplish this, all data traffic addressed to any specific broadband branch, undergoes hierarchical traffic management taking into account various bottlenecks along its route.

To sum up the situation,
1. Flow control is inadequate. Flow control does not scale, and provides poor resource utilization.
2. Hierarchical traffic management is an over-kill. Hierarchical traffic management performs well, but is excessively expensive if traversed by the entire data traffic.

As such, it would be of advantage to control traffic in a way that overcomes the scalability limitation of flow control, and avoids congestion when multiple traffic sources are present in the network.

### SUMMARY OF THE DESCRIPTION

Aspects of the present invention relate to novel systems and methods for controlling data traffic to avoid congestion in a network that has multiple sources of traffic. Moreover, the sources may introduce traffic into the network downstream of an edge router. These systems and methods are scalable, and overcome the scalability limitations of flow control.

Embodiments of the present invention provide a novel network controller, which periodically gathers statistical traffic data from networks nodes and from one or more edge routers in a data network, and which uses these statistics to analyze traffic distribution from traffic sources on various network links. The controller calculates permitted capacities, i.e., maximum allowed rates, on links downstream of the edge routers. The thus-calculated permitted capacities are in turn used to dynamically configure the hierarchical scheduling and policing tree of one or more of the edge routers, thereby ensuring that the edge routers prevent traffic congestion in the network, and ensuring fairness among customers—despite the edge routers being located upstream of where the traffic sources enter the network.

The present invention is of particular advantage for software-defined networks (SDNs), which separate the data plane from the control plane.

There is thus provided in accordance with an embodiment of the present invention a traffic controller for a data network that includes a plurality of network nodes, a plurality of network links connecting the network nodes, and one or more edge routers, each edge router being configured to control network traffic based on permitted link capacities, and wherein one or more sources of downstream traffic data enter the network downstream of the one or more edge routers, the traffic controller including a receiver operable to periodically receive downstream transmission byte counts from at least some of the network nodes, a processor coupled with the receiver, operable to periodically update the permitted link capacities based on the network node downstream byte counts received by the receiver, and a transmitter coupled with the processor operable to periodically transmit the thus-updated permitted link capacities to the one or more edge routers for their use in controlling the network traffic.

There is additionally provided in accordance with an embodiment of the present invention a non-transitory computer readable medium storing a computer program with computer program code, which, when read by a controller device, causes the controller device to perform a method for controlling traffic in a data network that includes a plurality of network nodes, a plurality of network links connecting the network nodes, and one or more edge routers, each edge router being configured to control network traffic based on permitted link capacities, and wherein one or more sources of downstream traffic data enter the network downstream of the one or more edge routers, the method including periodically receiving downstream transmission byte counts from at least some of the network nodes, periodically updating permitted link capacities based on the network node downstream byte counts received by the periodically receiving, and periodically transmitting the thus-updated permitted link capacities, calculated by the periodically updating, to the one or more edge routers for their use in controlling the network traffic.

### BRIEF DESCRIPTION OF THE DRAWINGS

The present invention will be more fully understood and appreciated from the following detailed description, taken in conjunction with the drawings in which:

FIG. 1 is a prior art diagram of a provider data network;

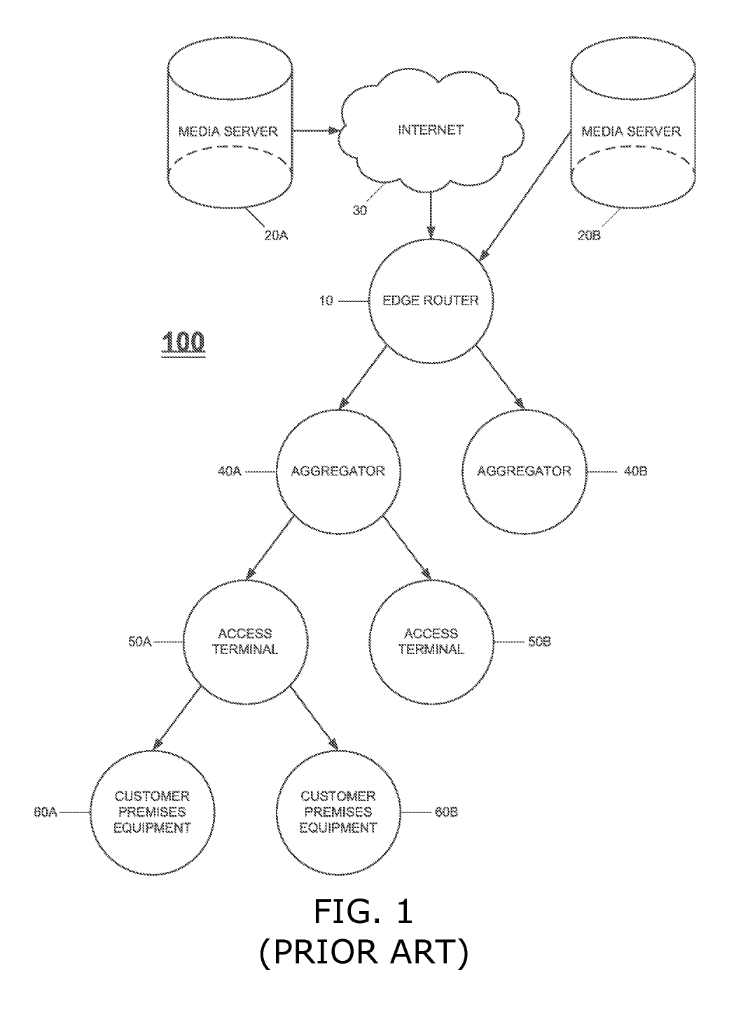

FIG. 2 is a simplified block diagram of an enhanced data network with media servers entering the network downstream of an edge router, in accordance with an embodiment of the present invention;

FIG. 3 is a simplified block diagram of an enhanced data network with a traffic controller, in accordance with an embodiment of the present invention;

FIG. 4 is a simplified block diagram of an enhanced data network with two edge routers and a traffic controller, in accordance with an embodiment of the present invention;

FIG. 5 is a simplified block diagram of the traffic controller of FIGS. 3 and 4, in accordance with an embodiment of the present invention; and

FIG. 6 is a simplified flowchart of a method performed by the traffic controller of FIGS. 3 and 4, in accordance with an embodiment of the present invention.

### DETAILED DESCRIPTION

Aspects of the present invention relate to a novel network controller, which enables edge routers to prevent traffic congestion in the network and ensure fairness among customers, despite the edge routers being located upstream of where network traffic sources such as media servers enter the network.

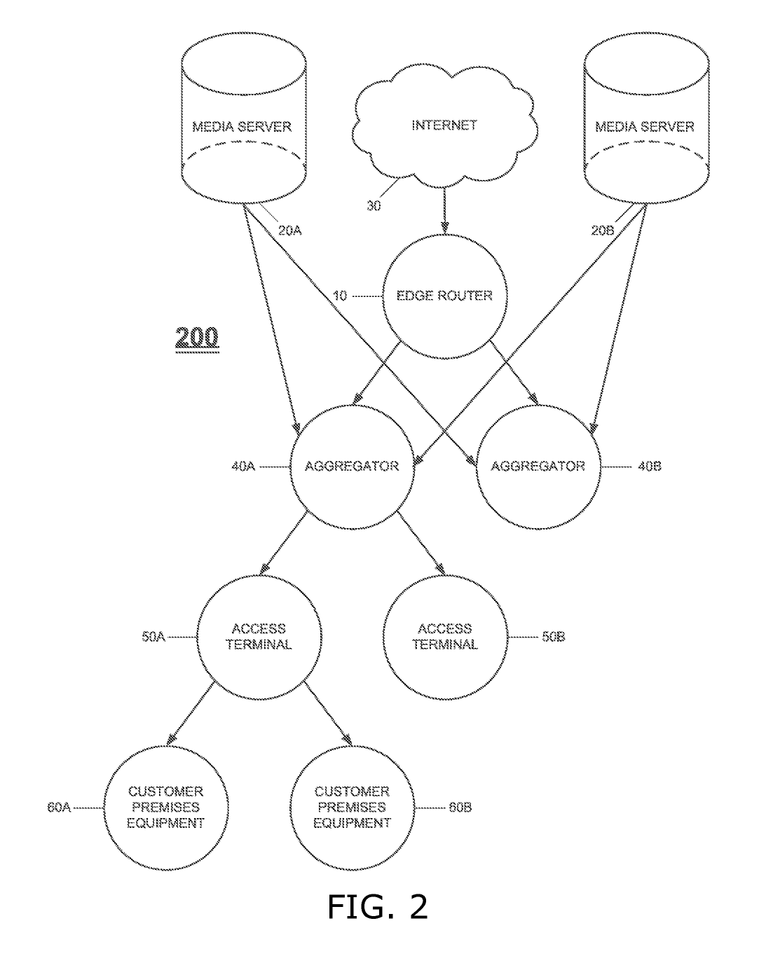

Reference is made to FIG. 2, which is a simplified block diagram of an enhanced data network 200 with media servers 20A and 20B entering network 200 downstream of edge router 10, in accordance with an embodiment of the present invention. Data network 200 may be inter alia a passive optical network, a cable network, a digital subscriber network, or a software-defined network.

As shown in FIG. 2, edge router 10 is offloaded, by connecting media servers 20A and 20B directly to aggregators 40A and 40B. The connection between the media servers and the aggregators may be a physical connection, and may be a connection that uses an optical transport network (OTN). Connecting media servers 20A and 20B directly to aggregators 40A and 40B has the important advantage of improving the user experience for customers who consume the media.

Edge router 10 cannot perform congestion avoidance and ensure fairness in network 200, since it is not aware of the media traffic generated by media servers 20A and 20B that flows through the network to CPEs 60A and 60B. Indeed, edge router 10 cannot determine the data traffic rates, since the sources of the data traffic do not flow into edge router 10. As such, conventional hierarchical scheduling and shaping cannot be used in system 200 to prevent congestion.

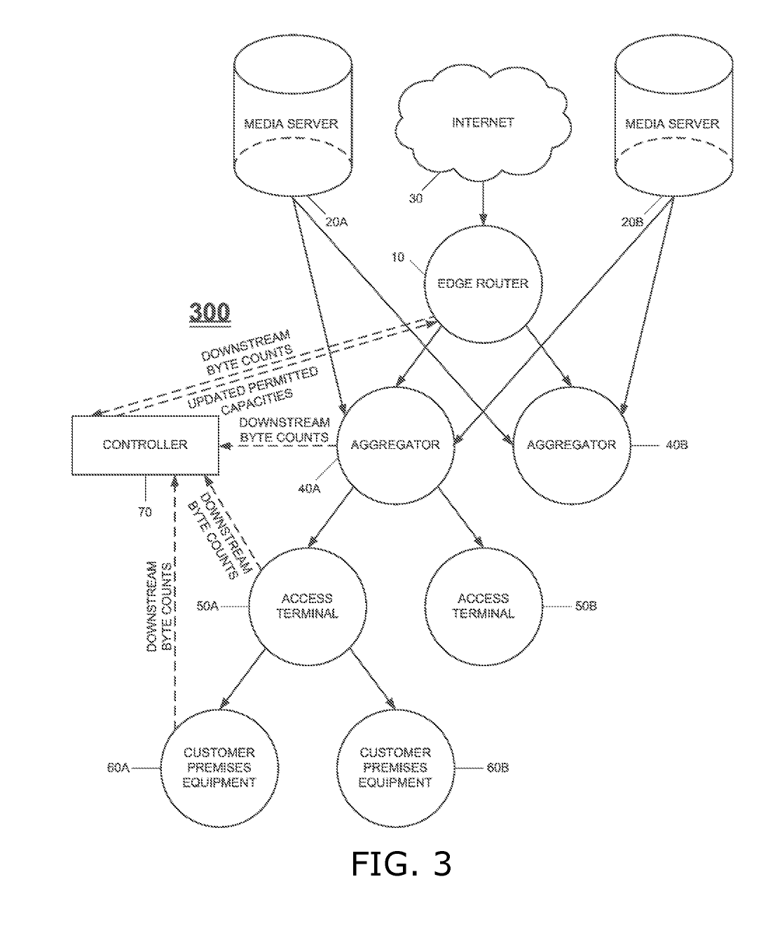

Reference is made to FIG. 3, which is a simplified block diagram of an enhanced data network 300 with a traffic controller 70, in accordance with an embodiment of the present invention. Controller 70 gathers statistics from some or all of the various network nodes, and from edge router 10. Controller 70 uses these statistics to dynamically configure edge router 10 so as to avoid congestion.

Controller 70 may be an additional network node added to the system, or alternatively it may be an existing network node that adopts the role of a controller. Controller 70 is a standard management entity, including inter alia a simple network management protocol (SNMP) manager or a software-defined network (SDN) controller, or an application over an SDN controller. Alternatively, controller 70 is a proprietary management entity.

Controller 70 collects information and statistical data from other network nodes, using a standard protocol including inter alia remote network monitoring (RMON), SNMP, operations administration and monitoring (OAM) protocol, and the Broadband Forum TR-69 management protocol. Alternatively, controller 70 collects the information and statistical data using proprietary protocols.

Controller 70 reads information from other network nodes, the information including inter alia, for each network node, one or more of:
I. a unique identifier for the network node;
II. network links available to the network node, their capacities, and the identifiers of their peer network nodes; and
III. received and transmitted byte counters, per network link connected to the network node.
   It is noted that information I and II suffices for controller 70 to reconstruct the network topology. Alternatively, the network topology may be provided in advance to controller 70.

Controller 70 writes to the hierarchical scheduling and policing tree of edge router 10, and reads information from the tree, including one or more of:
IV. transmitting downstream byte counter at each tree edge nm; and
V. transmitted downstream byte counter at each tree leaf l.

Controller 70 periodically identifies changes in the topology and link capacity information, and adjust its decisions. When such changes are identified, controller 70 notifies an operator that the discovered topology and link capacities do not match the edge router hierarchical scheduling tree. Further, when such changes are identified, controller 70 updates the edge router hierarchical scheduling, based on the updated topology and link capacity information, and notifies the operator accordingly.

The following notation is introduced.
Txₗ(t)—the downstream transmitted byte counter at time t of leaf l;
Tx_{n,m}(t)—the downstream transmitted byte counter at time t of node n towards downstream node m;
Corig_{n,m}—the originally set permitted capacity of the edge from node n to downstream node m; and
C_{n,m}—the current permitted capacity of the edge from node n to downstream node m.
   Since downstream traffic is distributed in a tree structure, it is noted that

$${Tx}_{n , m} = \{ \begin{matrix}{\sum }_{edges m , k} {Tx}_{m , k} ( t ) , & if m is not a leaf \\ {Tx}_{l} ( t ) , & if l is a leaf\end{matrix} . \qquad ( 1 )$$

EQ. 1 may be applied recursively to derive the counters Tx_{n,m}(t) from the counters Txₗ(t). As such, information V suffices to determine information IV.

Upon initialization, controller 70 reads the initial hierarchical scheduling and policing tree configuration, including the tree structure and the original edge capacities Corig_{n,m}.

In accordance with an embodiment of the present invention, controller 70 periodically reads available information from the network nodes and from edge router 10, and derives traffic rates R_{n,m} from node n to downstream node m, in accordance with the formula

$${R}_{n , m} = \frac{{Tx}_{n , m} ( {t}_{1} ) - {Tx}_{n , m} ( {t}_{0} )}{{t}_{1} - {t}_{0}} . \qquad ( 2 )$$

EQ. 2 uses information III from the network nodes, and information IV or V from edge router 10. Denoting, as above, the data traffic rates determined by edge router 10 by Redge_{n,m}, it is noted that Redge_{n,m}≦R_{n,m}, and Redge_{n,m}≦Corig_{n,m}. If information III is permanently not available to controller 70, then controller 70 sets the rate R_{n,m}=Redge_{n,m}. If information III is temporarily not available to controller 70, then controller 70 uses a prediction based on previous information III that was available, to determine the rate R_{n,m}; e.g., a predictor based on a sliding window average or based on linear approximation.

After calculating the rates R_{n,m}, controller 70 dynamically updates the current permitted capacities C_{n,m} of each edge of the hierarchical scheduling and policing tree, according to the formula

C_{n,m}=max{Corig_{n,m}−(R_{n,m}−Redge_{n,m}),0}. (3)

The updated edge capacities C_{n,m} in accordance with EQ. 3 are then used to dynamically update the configuration of edge router 10, thereby avoiding traffic congestion in the network nodes that receive traffic from edge router 10. It will be appreciated by those skilled in the art that use of EQ. 3 enables edge router 10 to accommodate sources of data traffic, such as media servers 20A and 20B, which do not flow through edge router 10.

Updating of capacities and updating of the configuration of edge router 10 are preferably performed frequently enough to follow traffic source rate changes, but without overloading the network nodes with statistics requests.

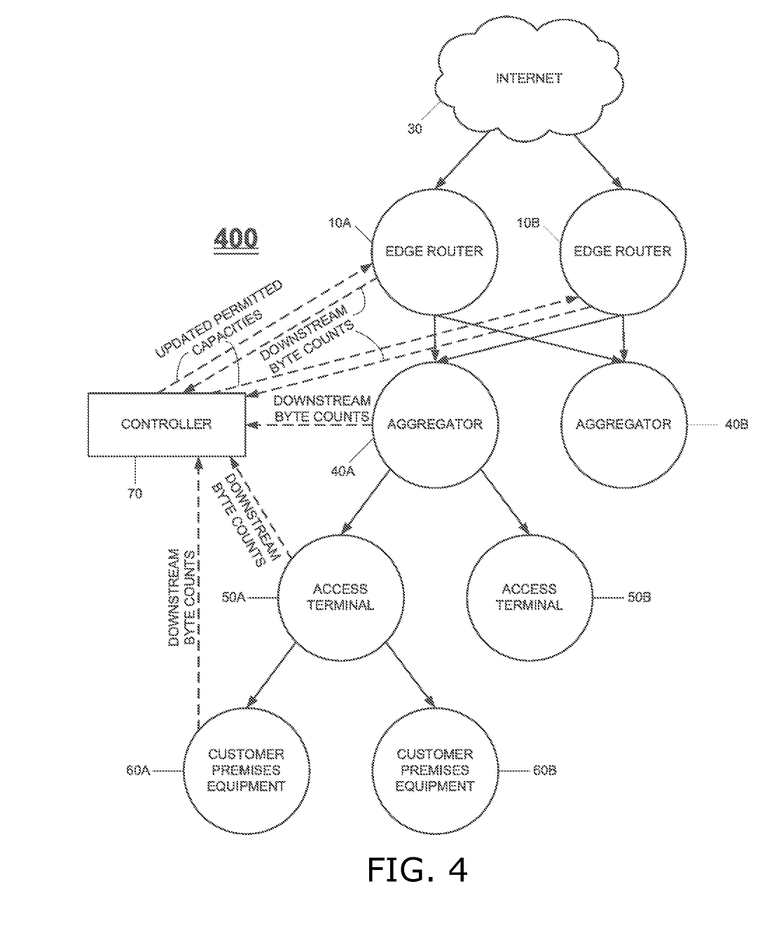

Reference is made to FIG. 4, which is a simplified block diagram of an enhanced data network 400 with traffic controller 70, and with two edge routers 10A and 10B that share the network capacity, in accordance with an embodiment of the present invention. Controller 70 gathers statistics from some or all of the various network nodes, and from edge routers 10A and 10B. Controller 70 uses these statistics to dynamically configure edge routers 10A and 10B so as to avoid congestion.

When two or more edge routers are present in the network, such as edge routers 10A and 10B, the capacity updating procedure of EQ. 3 is performed for each edge router. It is noted, however, that the node calculations need only be performed once.

It is further noted that if one edge router, say edge router 10A, becomes inactive, then controller 70 instructs the other edge router, namely, edge router 10B, to use the entire network capacity. It will be appreciated by those skilled in the art that this serves as a failure protection mechanism for the network.

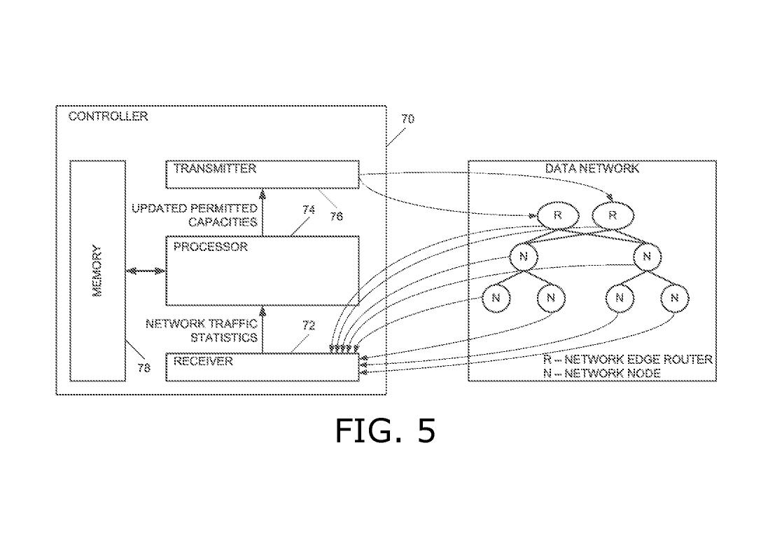

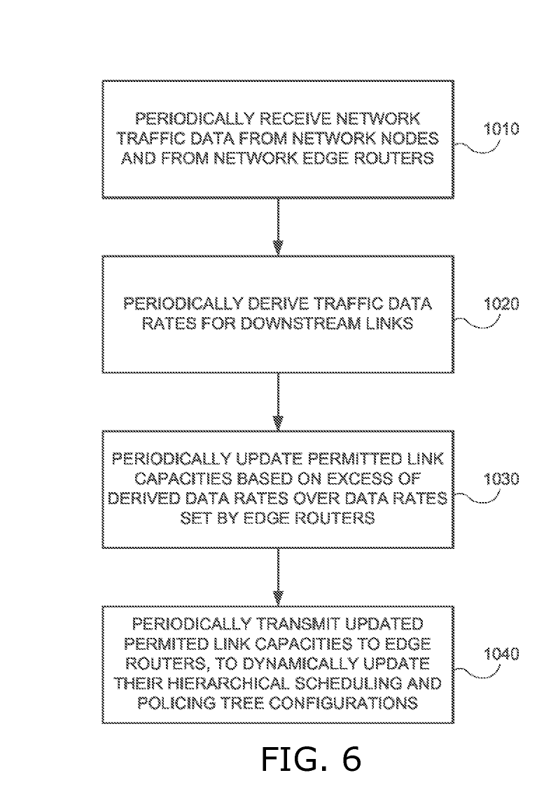

Reference is made to FIG. 5, which is a simplified block diagram of traffic controller 70, in accordance with an embodiment of the present invention. As shown in FIG. 5, controller 70 includes four primary components. A receiver 72 periodically receives statistical traffic data from some or all of the nodes in a data network, the statistical traffic data including byte counter data Txₗ(t) and Tx_{n,m}(t), discussed above. A processor 74 uses the byte counter data to periodically derive traffic rates R_{n,m} in accordance with EQ. 2, and to periodically update permitted edge capacities C_{n,m} in accordance with EQ. 3. The updated permitted edge capacities incorporate traffic sources that enter the network downstream of the edge routers. A transmitter 76 transmits the updated permitted edge capacities to one or more edge routers in the data network, for dynamically updating their hierarchical scheduling and policing tree configurations so as to accommodate the updated permitted edge capacities and thereby prevent congestion. A memory 78 stores the program code instructions that are executed by processor 74 to perform the method shown below in FIG. 6, which controls receiver 72, performs the processing for updating the permitted link capacities, and controls transmitter 76.

Transmitter 76 queries the nodes for their statistics, for the next calculation cycle. In an alternative embodiment of the present invention, controller 70 configures the nodes to periodically send their statistics to transmitter 76.

FIG. 6 is a simplified flowchart of a method performed by traffic controller 70, in accordance with an embodiment of the present invention. At operation 1010, controller 70 periodically receives network traffic data from network nodes and from network edge routers. The received data includes byte counter data Txₗ(t) and Tx_{n,m}(t), discussed above. At operation 1020, controller 70 periodically derives traffic data rates R_{n,m} in accordance with EQ. 2. At operation 1030, controller 70 periodically updates the permitted edge capacities C_{n,m} in accordance with EQ. 3. The updated permitted edge capacities incorporate traffic sources that enter the network downstream of the edge routers. At operation 1040, controller 70 periodically transmits the updated permitted edge capacities C_{n,m} to the edge routers, for dynamically updating their hierarchical scheduling and policing tree configurations so as to accommodate the updated permitted edge capacities and thereby prevent congestion.

It will be appreciated by those skilled in the art that the present invention has broad application to any data network that supports two or more network nodes that pass traffic from one or more sources into the network, such that one or more of the traffic sources has a connection to a device capable of performing hierarchical schedule and shaping, and such that some or all of the network nodes are capable of providing statistics regarding traffic passing through them.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A traffic controller for a data network that comprises a plurality of network nodes, a plurality of network links connecting the network nodes, and one or more edge routers, each edge router being configured to control network traffic based on permitted link capacities, and wherein one or more sources of downstream traffic data enter the network downstream of the one or more edge routers, the traffic controller comprising:
a receiver operable to periodically receive downstream transmission byte counts from at least some of the network nodes;
a processor coupled with said receiver, operable to periodically update the permitted link capacities based on the network node downstream byte counts received by said receiver; and
a transmitter coupled with said processor operable to periodically transmit the thus-updated permitted link capacities to the one or more edge routers for their use in controlling the network traffic.

2. The traffic controller of claim 1 wherein said processor is operable to periodically derive downstream data rates as differences in network node downstream byte counts over time intervals divided by the lengths of the time intervals, and to use the thus-derived downstream data rates to update the permitted link capacities.

3. The traffic controller of claim 2 wherein the permitted link capacities are updated by subtracting excesses of the downstream data rates derived by said processor over the downstream data rates derived by edge routers, from originally set permitted link capacities.

4. The traffic controller of claim 1 further comprising a network connection, for connecting the traffic controller with the at least some of the network nodes.

5. The traffic controller of claim 1 wherein said receiver uses the remote network monitoring (RMON) protocol, the simple network management protocol (SNMP), the operations administration and monitoring (OAM) protocol, or the Broadband Forum TR-69 management protocol.

6. The traffic controller of claim 1 wherein the traffic controller is itself one of the plurality of network nodes.

7. The traffic controller of claim 1 wherein the data network comprises a passive optical network, a cable network, a digital subscriber network, or a software-defined network (SDN).

8. The traffic controller of claim 1 wherein the data network comprises a provider network that provides at least one of voice services, video services, on-line gaming services, file sharing services, data backup services, and cloud storage services.

9. The traffic controller of claim 1 wherein said receiver, said processor and said transmitter are operable to periodically receive, calculate and transmit, respectively, at time intervals of approximately 100 ms.

10. A data network with a controller in accordance with claim 1 for preventing traffic congestion, the data network comprising:
a plurality of network nodes;
a plurality of network links connecting the network nodes;
one or more edge routers, each edge router being configured to control network traffic based on permitted link capacities; and
the traffic controller of claim 1,
wherein one or more sources of downstream traffic data enter the network downstream of the one or more edge routers.

11. A non-transitory computer readable medium storing a computer program with computer program code, which, when read by a controller device, causes the controller device to perform a method for controlling traffic in a data network that comprises a plurality of network nodes, a plurality of network links connecting the network nodes, and one or more edge routers, each edge router being configured to control network traffic based on permitted link capacities, and wherein one or more sources of downstream traffic data enter the network downstream of the one or more edge routers, the method comprising:
periodically receiving downstream transmission byte counts from at least some of the network nodes;
periodically updating permitted link capacities based on the network node downstream byte counts received by said periodically receiving; and
periodically transmitting the thus-updated permitted link capacities, calculated by said periodically updating, to the one or more edge routers for their use in controlling the network traffic.

12. The computer readable medium of claim 11 wherein the method further comprises periodically deriving downstream data rates as differences in network node downstream byte counts over time intervals divided by the lengths of the time intervals, and wherein said periodically updating uses the downstream data rates derived by said periodically deriving, to calculate the updated permitted link capacities.

13. The computer readable medium of claim 12 wherein said periodically updating comprises periodically subtracting excesses of the downstream data rates derived by said periodically deriving over the downstream data rates derived by edge routers, from originally set permitted link capacities.

14. The computer readable medium of claim 11 wherein said periodically receiving uses the remote network monitoring (RMON) protocol, the simple network management protocol (SNMP), the operations administration and monitoring (OAM) protocol, or the Broadband Forum TR-69 management protocol.

15. The computer readable medium of claim 11 wherein the computer program code causes the controller device to perform said periodically receiving, said periodically updating and said periodically transmitting at time intervals of approximately 100 ms.
